(19) United States
(12) Patent Application Publication
(10) Pub. No.: US 2023/0185468 A1
(43) Pub. Date: Jun. 15, 2023

(54) INFORMATION PROCESSING DEVICE AND METHOD

(71) Applicant: Kioxia Corporation, Tokyo (JP)

(72) Inventors: Taiga IKEDA, Kawasaki (JP); Daisuke MIYASHITA, Kawasaki (JP); Jun DEGUCHI, Kawasaki (JP); Asuka MAKI, Kawasaki (JP)

(73) Assignee: Kioxia Corporation, Tokyo (JP)

(21) Appl. No.: 17/840,981

(22) Filed: Jun. 15, 2022

(30) Foreign Application Priority Data
Dec. 10, 2021 (JP) 2021-201065

(51) Int. Cl. G06F 3/06; G06F 12/02

(52) U.S. Cl. CPC G06F 3/0638; G06F 3/0611; G06F 3/0685; G06F 12/023; G06F 2212/1024

(57) ABSTRACT

An information processing device includes a first memory, a second memory, and a processor. The first memory stores clusters into which first data segments are grouped according to distances among the first data segments and each including one or more first data segments. The second memory is operable at a higher speed than the first memory and stores second data segments corresponding one-to-one to the clusters. The processor receives an input query and identify a third data segment being one of the second data segments closest to the query, from the second data segments. The processor collectively reads, from the first memory, one or more first data segments included in a cluster corresponding to the third data segment among the clusters, and identify a fourth data segment being one of the first data segments closest to the query from the one or more first data segments for output.

### CROSS-REFERENCE TO RELATED APPLICATIONS

This application is based upon and claims the benefit of priority from Japanese Patent Application No. 2021-201065 filed on Dec. 10, 2021; the entire contents of which are incorporated herein by reference.

### FIELD

Embodiments described herein relate generally to an information processing device and method.

### BACKGROUND

Traditionally, information processing devices or methods are available, which perform search for a data segment similar to a query being an input data segment to output a result of the search responsive to the query. Such a device or method is required to achieve higher search accuracy and a higher query response speed in information processing to output the result to the query. Among nearest neighbor search algorithms for satisfying both query response speed and search accuracy, an approximate nearest neighbor search (ANNS) algorithm using a plurality of heterogeneous memories is known.

### BRIEF DESCRIPTION OF THE DRAWINGS

FIG. 1 is a schematic diagram illustrating an exemplary hardware configuration of an information processing device according to an embodiment;

FIG. 2 is a schematic diagram illustrating a usage example of an SSD according to an embodiment;

FIG. 3 is a schematic diagram for explaining a nearest neighbor search to be executed by a processor according to an embodiment;

FIG. 4 is a schematic diagram illustrating a usage example of a DRAM according to an embodiment;

FIG. 5 is a schematic diagram illustrating an exemplary arrangement method of representative data segments and data segments according to an embodiment;

FIG. 6 is a flowchart illustrating an exemplary procedure of storing data segments into the SSD to be executed by the information processing device according to an embodiment;

FIG. 7 is a flowchart illustrating an exemplary procedure of a nearest neighbor search to be executed by the information processing device according to an embodiment;

FIG. 8 is a schematic diagram for explaining a clustering method according to a modification of the embodiments; and

FIG. 9 is a schematic diagram illustrating an exemplary data segment arrangement method according to the modification of the embodiments.

### DETAILED DESCRIPTION

According to one embodiment, in general, an information processing device includes a first memory, a second memory, and a processor. The first memory is configured to store a plurality of clusters into which a plurality of first data segments is grouped according to a distance between the first data segments and each of which includes one or more first data segments. The second memory is operable at a higher speed than the first memory and configured to store a plurality of second data segments corresponding one-to-one to the plurality of clusters. The plurality of second data segments is representative of the corresponding clusters. The processor is configured to receive an input query and identify a third data segment from among the plurality of second data segments. The third data segment is one of the second data segments closest to the query. The processor collectively reads, from the first memory, one or more first data segments included in a cluster corresponding to the third data segment among the plurality of clusters, and identify a fourth data segment from among the one or more first data segments. The fourth data segment is one of the first data segments closest to the query. The processor outputs the fourth data segment.

A nearest neighbor search according to an embodiment is executed by, for example, an information processing device including a processor, a first memory, and a second memory. The first memory has a larger capacity than the second memory. The second memory is operable at a higher speed than the first memory. The following will describe an example that a nearest neighbor search of an embodiment is executed by a computer including a solid state drive (SSD) as the first memory and a dynamic random access memory (DRAM) as the second memory.

Alternatively, the nearest neighbor search of an embodiment may be executed by cooperation of two or more information processing devices mutually connected via a network. In addition, the nearest neighbor search of an embodiment may be executed by a storage device including a storage medium such as a NAND flash memory chip as the first memory, a DRAM as the second memory, and a processor.

Hereinafter, an information processing device and method according to embodiments will be described in detail with reference to the accompanying drawings. The embodiments are presented for illustrative purpose only and not intended to limit the scope of the inventions.

### Embodiment

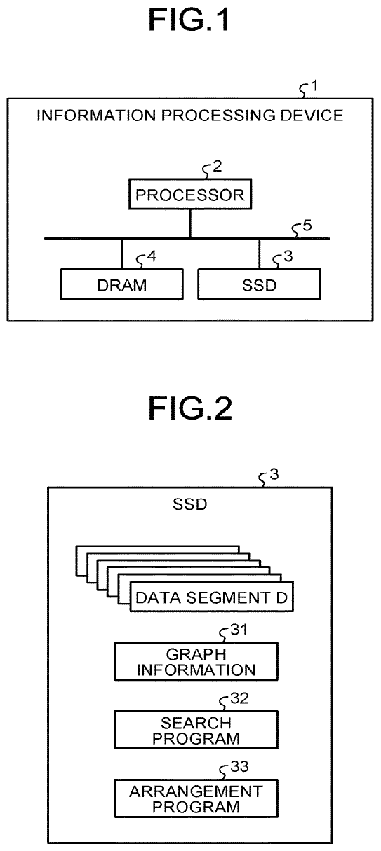

FIG. 1 is a schematic diagram illustrating an exemplary hardware configuration of an information processing device according to an embodiment.

The information processing device 1 is exemplified by a computer including a processor 2, an SSD 3 serving as an exemplary first memory, a DRAM 4 serving as an exemplary second memory, and a bus 5 that electrically connects these elements. The first memory and the second memory are not limited thereto. For example, the first memory may be any storage memory. The first memory may be a universal flash storage (UFS) device or a magnetic disk device.

The processor 2 serves to execute given computations according to a computer program. Examples of the processor 2 includes a central processing unit (CPU). In response to receipt of a query as an input data segment by the information processing device 1, the processor 2 uses the SSD 3 and the DRAM 4 to execute given computations based on the input query.

The SSD 3 is a storage memory having a large capacity. The SSD 3 includes a NAND flash memory as a storage medium.

The DRAM 4 has a smaller capacity than the SSD 3 but is operable at a higher speed than the SSD 3.

The information processing device 1 may be connected to any input/output device or devices. Examples of the input/output device include an input device, a display device, a networking device, and a printer.

FIG. 2 is a schematic diagram illustrating a usage example of the SSD 3 according to an embodiment.

The SSD 3 stores a plurality of data segments D. The type of data segments D is not limited to a particular type. Each data segment D represents an image, a document, or any other type of information. All the data segments D have the same size. The data segments D can be subjected to a nearest neighbor search.

In response to an input data segment being a query to the information processing device 1, the processor 2 searches the SSD 3 for a data segment D located in a closest distance to the input query among the stored data segments D.

Herein, the distance refers to a unit of measurement or a scale representing similarity between data segments. The distance is mathematically the Euclidean distance, for example. The mathematical definition of the distance is not limited to the Euclidean distance.

The processor 2 may search for multiple data segments D closest to the query in the nearest neighbor search.

The plurality of data segments D forms a graph. The graph herein refers to a data segment structure in which multiple nodes are mutually connected via edges. In this case, each data segment D corresponds to a node. The designer or a given computer program generates in advance graph information 31 for defining connections among the nodes. The graph information 31 is stored in the SSD 3.

In addition, the SSD 3 stores a search program 32 and an arrangement program 33. The search program 32 is a computer program that causes the processor 2 to execute a nearest neighbor search. The arrangement program 33 is a computer program that causes the processor 2 to arrange the data segments D, for example. The processor 2 loads the search program 32 and the arrangement program 33 from the SSD 3 into the DRAM 4 to execute these programs. A method for arranging the data segments D by the arrangement program 33 will be described later.

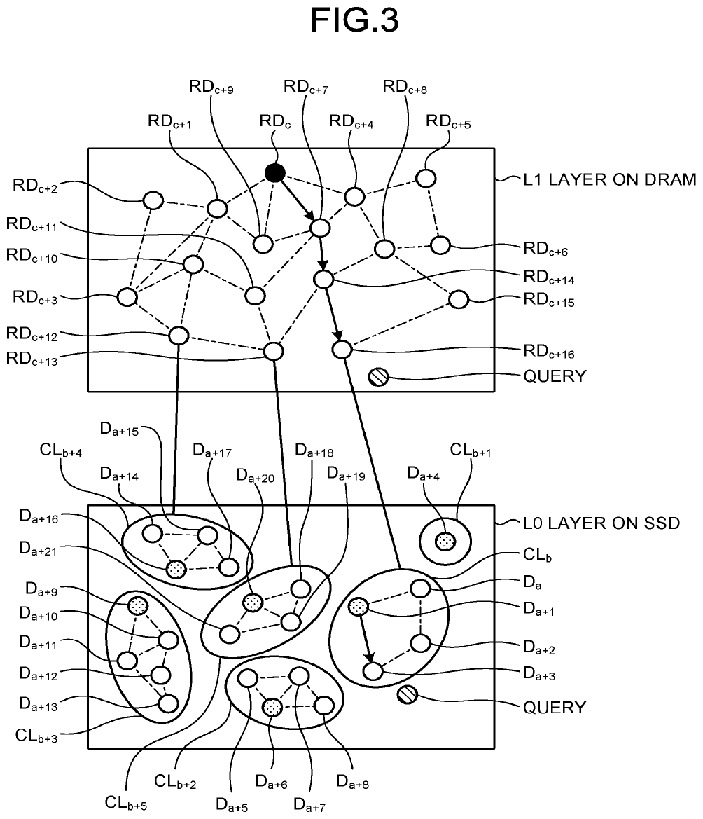

FIG. 3 is a schematic diagram for explaining a nearest neighbor search to be executed by the processor 2 in an embodiment.

In an embodiment a search space is hierarchized into a plurality of layers. As an example, the search space includes two layers, i.e., an L0 layer and an L1 layer.

The L0 layer is a space in which the data segments D stored in the SSD 3 are distributed. Among the data segments D stored in the SSD 3, two or more data segments D in a close distance therebetween constitute one cluster CL. Thus, the L0 layer includes a plurality of clusters CL. The data segments D constituting the L0 layer are grouped into a plurality of clusters CL according to the distances among the data segments D. The data segments D may be grouped into clusters in any manner as long as the clustering bases on the distances among the data segments D. For example, the space of the L0 layer may be divided into a grid form to define a set of data segments D located in each grid as one cluster CL. Thereby, two or more data segments D in a close distance to each other can be grouped into one cluster CL.

The numbers of data segments D included in each cluster CL may or may not be all the same. In addition, there may be a cluster or clusters CL including one data segment D.

FIG. 3 depicts part of the data segments D included in the L0 layer, i.e., a total of 22 data segments Dₐ to Dₐ₊₂₁. A set of data segments Dₐ to Dₐ₊₃ constitutes a cluster CL_{b}. A set of data segment Dₐ₊₄ constitutes a cluster CL_{b+1}. A set of data segments Dₐ₊₅ to Dₐ₊₈ constitutes a cluster CL_{b+2}. A set of data segments Dₐ₊₉ to Dₐ₊₁₃ constitutes a cluster CL_{b+3}. A set of data segments Dₐ₊₁₄ to Dₐ₊₁₇ constitutes a cluster CL_{b+4}. A set of data segments Dₐ₊₁₈ to Dₐ₊₂₁ constitutes a cluster CL_{b+5}. In this example, each data segment D can be included in only one cluster CL.

The set of data segments D constituting each cluster CL forms a graph. In the L0 layer of FIG. 3, the dashed-dotted line represents edges connecting the data segments D. Data segments Dₐ₊₁, Dₐ₊₄, Dₐ₊₆, Dₐ₊₉, Dₐ₊₁₆, and Dₐ₊₂₀, as indicated by dot-hatched circles, represent nodes serving as a search starting point, i.e., an entry point of the clusters CL. The entry point is set in each cluster CL. The graph information 31 contains graph structures of the respective clusters CL in the L0 layer. The entry points of the respective clusters CL may be included in the graph information 31 or in any other information.

A representative data segment RD of each set of data segments D included in the cluster CL is obtained by computation from each cluster CL. Hereinafter, the cluster CL from which a representative data segment RD is obtained by computation is referred to as a cluster CL corresponding to a representative data segment RD.

The method for computing the representative data segment RD is not limited to a particular method. As an example, the representative data segment RD may be selected by any method from the set of data segments D constituting the corresponding cluster CL. For example, the representative data segment RD of each cluster CL may be set to a data segment D closest to the center of the cluster CL among the set of data segments D. Alternatively, the representative data segment RD may be obtained by any mathematical operation from the set of data segments D constituting the corresponding cluster CL. For example, the representative data segment RD of the cluster CL may be set to an average of the set of data segments D. The processor 2 may compute the representative data segment RD of each cluster CL or the designer may compute that in advance. The representative data segments RD of all the clusters CL have the same size.

The representative data segments RD of all the clusters CL constitute the L1 layer.

FIG. 3 depicts a part of the representative data segments RD constituting the L1 layer, i.e., a total of 17 representative data segments RD_{c} to RD_{c+16}. The representative data segments RD_{c} to RD_{c+16} correspond one-to-one to the clusters CL included in the L0 layer. In this example, the representative data segment RD_{c+12} corresponds to the cluster CL_{b+4}, the representative data segment RD_{c+13} corresponds to the cluster CL_{b+5}, and the representative data segment RD_{c+16} corresponds to the cluster CL_{b}.

The set of representative data segments RD in the L1 layer forms a graph. In the L1 layer of FIG. 3, the dashed-dotted line represents edges connecting the representative data segments RD. The representative data segment RD_{c}, as indicated by the black-color circle, represents an entry point in the L1 layer. The graph information 31 contains the graph structure of the L1 layer. The entry point in the L1 layer may be included in the graph information 31 or in any other information.

The representative data segments RD of all the clusters CL are stored in the DRAM 4. In response to an input query, the processor 2 first performs a nearest neighbor search in the L1 layer according to the graph. Access to the DRAM 4 is faster than access to the SSD 3. The nearest neighbor search is thus executed in the L1 layer at a higher speed.

For example, the processor 2 first selects a representative data segment RD_{c} serving as an entry point. The processor 2 then computes the distances to the query from each of the representative data segment RD_{c} and the representative data segments RD_{c+1}, RD_{c+4}, RD_{c+7}, and RD_{c+9} connected to the representative data segment RD_{c} via the edges, and selects the representative data segment RD_{c+7} closest to the query from among the representative data segments RD_{c}, RD_{c+1}, RD_{c+4}, RD_{c+7}, and RD_{c+9}. The processor 2 computes the distances to the query from each of the selected representative data segment RD_{c+7} and the representative data segments RD_{c}, RD_{c+4}, RD_{c+9}, RD_{c+11}, and RD_{c+14} connected to the representative data segment RD_{c+7} via the edges, and selects another representative data segment RD_{c+14} closest to the query from among these representative data segments. In this manner, the processor 2 identifies the representative data segment RD closest to the query from among all the representative data segments RD through the nearest neighbor search following the graph.

Selecting another node connected to a selected node via an edge in a graph is referred to as hopping.

After identifying the representative data segment RD closest to the query, the processor 2 collectively reads the set of data segments D constituting the cluster CL corresponding to the identified representative data segment RD from the SSD 3 for storage in the DRAM 4. The processor 2 then performs a nearest neighbor search to the set of data segments D stored in the DRAM 4 according to the graph to identify a data segment D closest to the query. The processor 2 outputs the identified data segment D as a response to the query.

In the example illustrated in FIG. 3, in response to an input query, the processor 2 hops in order starting from the representative data segment RD_{c}, following the arrows, and identifies the representative data segment RD_{c+16} as the representative data segment RD closest to the query. The processor 2 reads all the data segments Dₐ to Dₐ₊₃ constituting the cluster CL_{b} corresponding to the representative data segment RD_{c+16} from the SSD 3 and stores the data segments Dₐ to Dₐ₊₃ into the DRAM 4. The processor 2 executes a nearest neighbor search to the data segments Dₐ to Dₐ₊₃ stored in the DRAM 4. In the cluster CL_{b}, the data segment Dₐ₊₁ is set as an entry point. The processor 2 performs hopping from the data segment Dₐ₊₁, as indicated by the arrow, to identify the data segment Dₐ₊₃ as the data segment D closest to the query and output the data segment Dₐ₊₃ as a query response. In FIG. 3 the arrow indicating the order of hopping in the nearest neighbor search with respect to the data segments Dₐ to Dₐ₊₃ is rendered on the set of the data segments Dₐ to Dₐ₊₃ in the SSD 3 for the sake of simple explanation. In reality, however, the data segments Dₐ to Dₐ₊₃ are stored in the DRAM 4, and the data segments Dₐ to Dₐ₊₃ in the DRAM 4 are subjected to hopping in the nearest neighbor search in order indicated by the arrow, as described above.

A technique to be compared with an embodiment will be described. The technique to be compared with an embodiment is referred to as a comparative example. According to the comparative example, some data segments in an L0 layer constitute an L1 layer. All the data segments in the L0 layer form one graph, and all the data segments in the L1 layer form one graph. The data segments in the L0 layer are all stored in a storage memory such as an SSD. The data segments in the L1 layer are all stored in a memory operable at a higher speed than the storage memory, such as a DRAM. In response to an input query, a nearest neighbor search is performed in the L1 layer, following the graph, to identify a data segment closest to the query in the L1 layer. And then, another nearest neighbor search is performed in the L0 layer according to the graph, using the identified data segment as an entry point.

According to the comparative example, an access to the storage memory occurs upon each hopping during the nearest neighbor search in the L0 layer. Specifically, upon each hopping, all the data segments connected to the selected data segment via the edges are read from the storage memory. Thus, the larger the number of hops is, the longer the time taken for a query response is.

Meanwhile, according to the embodiments, all the data segments D constituting the cluster CL closest to the query are collectively read during the nearest neighbor search in the L0 layer. The data segment closest to the query can be identified through the nearest neighbor search with respect to only the read data segments D. This makes it possible to reduce the time required for accessing the storage memory and the query response time in the embodiments, in comparison with the comparative example. That is, the query response speed can be improved.

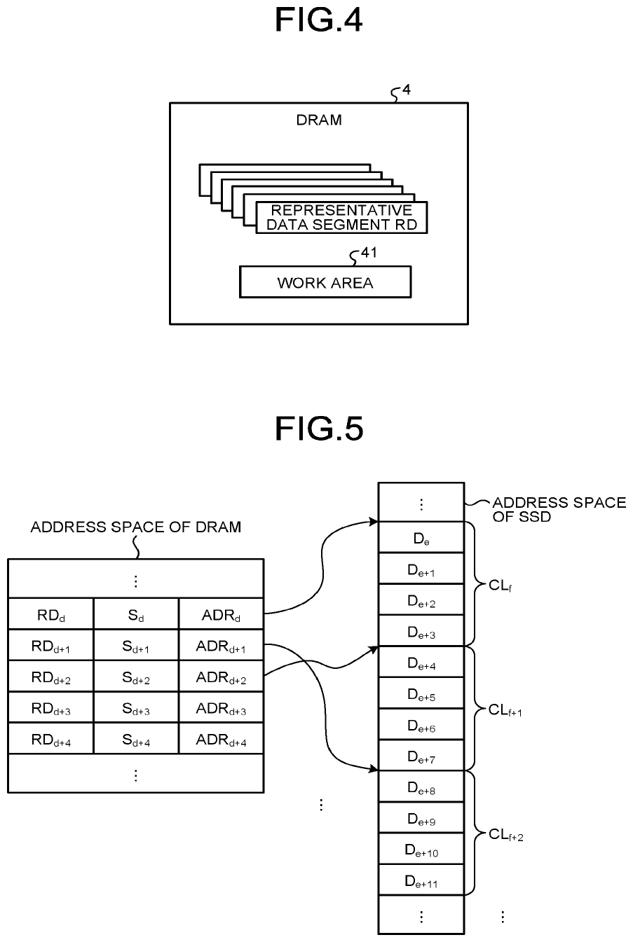

FIG. 4 is a schematic diagram illustrating a usage example of the DRAM 4 according to an embodiment.

The DRAM 4 stores all the representative data segments RD.

In addition the DRAM 4 includes a work area 41 for the processor 2. In the work area 41, various programs such as the arrangement program 33 or the search program 32 are loaded, the graph information 31 is buffered, and the set of data segments D constituting the cluster CL identified by the nearest neighbor search in the L1 layer is temporarily stored.

FIG. 5 is a schematic diagram illustrating an exemplary arrangement method of the representative data segments RD and data segments D in an embodiment. FIG. 5 depicts an address space of the DRAM 4 and an address space of the SSD 3. The address space of the DRAM 4 is defined by a range of addresses to be designated by the processor 2 when accessing the DRAM 4. The address space of the SSD 3 is defined by a range of addresses to be designated by the processor 2 when accessing the SSD 3.

A set of data segments D constituting each clusters CL is arranged in a continuous area in the address space of the SSD 3. In other words, one set of data segments D constituting one cluster CL is not arranged across two or more separate areas. For example, the processor 2 transmits, to the SSD 3, for a set of data segments D constituting an intended cluster CL (referred to as a target set), one read command including the head address of an area arranging the target set and a size of the target set. Thereby, the processor 2 can acquire the target set from the SSD 3 by one read command. Thus, the processor 2 can acquire all the data segments D to be used for the nearest neighbor search in the L0 layer through only a single read operation to the SSD 3.

Each of the representative data segments RD in the DRAM 4 is arranged in the address space of the DRAM 4 in association with an address ADR indicating the head and a size S of an area arranging the set of data segments D constituting the corresponding cluster CL. This makes it possible for the processor 2 to identify, from the representative data segment RD, the area arranging the set of data segments D constituting the cluster CL corresponding to the representative data segment RD.

In the example illustrated in FIG. 5, the cluster CL_{f} includes a set of data segments Dₑ to Dₑ₊₃, and the set of data segments Dₑ to Dₑ₊₃ is arranged in a continuous area of the address space of the SSD 3. The representative data segment RD_{d} obtained by computation from the cluster CL_{f} is stored in the DRAM 4 in association with the head address ADR_{d} and size S_{d} of the area arranging the set of data segments Dₑ to Dₑ₊₃.

The cluster CL_{f+1} includes a set of data segments Dₑ₊₄ to Dₑ₊₇ and the set of data segments Dₑ₊₄ to Dₑ₊₇ is arranged in a continuous area subsequent to the area arranging the set of data segments Dₑ to Dₑ₊₃ in the address space of the SSD 3. The representative data segment RD_{d+2} obtained by computation from the cluster CL_{f+1} is stored in the DRAM 4 in association with the head address ADR_{d+2} and size S_{d+2} of the area arranging the set of data segments Dₑ₊₄ to Dₑ₊₇.

The cluster CL_{f+2} includes a set of data segments Dₑ₊₈ to Dₑ₊₁₁, and the set of data segments Dₑ₊₈ to Dₑ₊₁₁ is arranged in a continuous area subsequent to the area arranging the set of data segments Dₑ₊₄ to Dₑ₊₇ in the address space of the SSD 3. The representative data segment RD_{d+1} obtained by computation from the cluster CL_{f+2} is stored in the DRAM 4 in association with the head address ADR_{d+1} and size S_{d+1} of the area arranging the set of data segments Dₑ₊₈ to Dₑ₊₁₁.

If all the clusters CL include the same number of data segments D, the information associated with each representative data segment RD may exclude the size S. In such a case, the processor 2 designates a predetermined size in reading a set of data segments D constituting an intended cluster CL from the SSD 3.

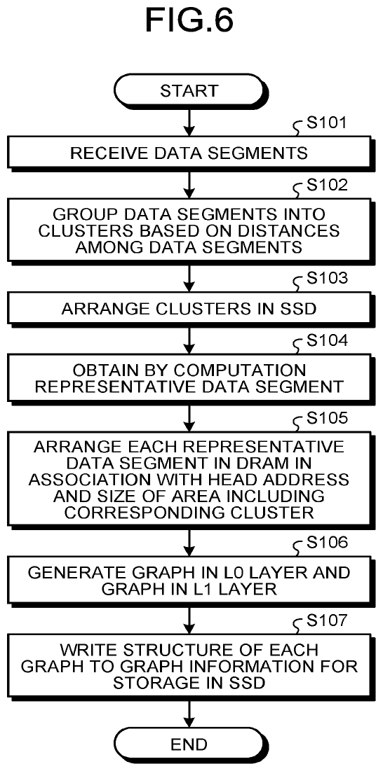

FIG. 6 is a flowchart illustrating an exemplary procedure of storing data segments D into the SSD 3 to be executed by the information processing device 1 in an embodiment. A series of operations illustrated in FIG. 6 is implemented by executing the arrangement program 33 by the processor 2. In place of the processor 2, the designer may perform the series of operations partially or entirely.

The information processing device 1 receives a plurality of data segments D (S101). The processor 2 groups the data segments D into a plurality of clusters CL in accordance with the distances among the data segments D (S102).

Subsequently, the processor 2 arranges the respective clusters CL in the SSD 3 (S103). In S103 the processor 2 arranges the set of data segments D constituting each cluster CL in a continuous area in the address space of the SSD 3, as described with reference to FIG. 5. For example, the processor 2 transmits a write command designating an arrangement area of each cluster CL to the SSD 3 to arrange the clusters CL therein.

The processor 2 computes a representative data segment RD for each cluster CL (S104). The processor 2 arranges the respective representative data segments RD in the DRAM 4 in association with the head addresses and sizes of the areas arranging the corresponding clusters CL in the address space of the SSD 3 (S105).

The processor 2 generates a graph in the L0 layer and a graph in the L1 layer (S106). The processor 2 writes the structures of the graphs to the graph information 31, and stores the graph information 31 into the SSD 3 (S107).

After S107, the storing process of the data segments D in the SSD 3 completes.

In response to an input of a new data segment D while the SSD 3 stores a plurality of data segments D, the processor 2 re-executes the operation in S102 and subsequent operations. In re-execution of the operations in S102 and thereafter, the processor 2 may perform the operations to all the data segments D, that is, the data segments D stored in the SSD 3 and the new input data segment D. Alternatively, the processor 2 may perform the operations to only the new input data segment D and the data segments D in a cluster CL adjacent to the new input data segment D.

The series of procedures described above is merely exemplary. The procedure of storing the data segments D in the SSD 3 is not limited to the above example as long as the data segments D and the representative data segments RD are arranged as illustrated in FIG. 5.

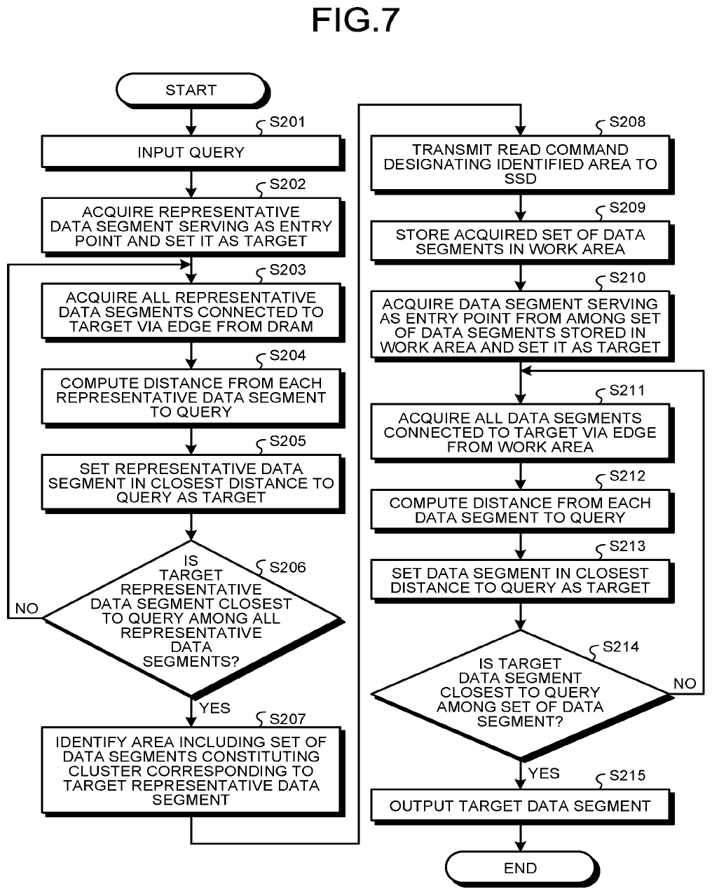

FIG. 7 is a flowchart illustrating an exemplary procedure of a nearest neighbor search to be executed by the information processing device 1 in an embodiment. A series of operations illustrated FIG. 7 is implemented by executing the search program 32 by the processor 2.

The information processing device 1 receives a query (S201). The processor 2 identifies a representative data segment RD closest to the query in the L1 layer through the operations from S202 to S206.

Specifically, the processor 2 acquires a representative data segment RD serving as an entry point from the DRAM 4 and sets the representative data segment RD as a target (S202). The processor 2 acquires all the representative data segments RD connected to the target representative data segment RD via the edges from the DRAM 4 (S203). The processor 2 computes the distances to the query from the target representative data segment RD and all the representative data segments RD connected to the target representative data segment RD via the edges (S204). The processor 2 sets the representative data segment RD located in a closest distance to the query as a target (S205). The processing from S203 to S205 completes a single hop in the L1 layer.

Following S205, the processor 2 determines whether the current target representative data segment RD is closest to the query among all the representative data segments RD (S206). The determination method in S206 is not limited to a particular method. For example, with no change of the target representative data segment RD in the previous processing from S203 to S205, it can be inferred that the current target representative data segment RD be closest to the query among all the representative data segments RD. Thus, with no change of the target representative data segment RD in the previous processing from S203 to S205, the processor 2 determines that the current target representative data segment RD is closest to the query among all the representative data segments RD. With a change of the target representative data segment RD in the previous processing from S203 to S205, the processor 2 determines that the current target representative data segment RD is not closest to the query.

When determining that the current target representative data segment RD is not closest to the query among all the representative data segments RD (S206: No), the processor 2 re-executes the processing from S203 to S206.

When determining that the current target representative data segment RD is closest to the query among all the representative data segments RD (S206: Yes), the processor 2 identifies the area arranging the set of data segments D constituting the cluster corresponding to the current target representative data segment RD (S207). In S207 the processor 2 acquires an address ADR and a size S associated with the current target representative data segment RD from the DRAM 4 to identify the area arranging the set of data segments D constituting the cluster corresponding to the current target representative data segment RD.

The processor 2 transmits a read command designating the identified area to the SSD 3 (S208). The SSD 3 outputs the set of data segments D in response to the read command, and the processor 2 stores the set of data segments D into the work area 41 (S209). The processor 2 then executes a nearest neighbor search to identify the data segment D closest to the query in the L0 layer through the operations from S210 to S214.

Specifically, the processor 2 acquires a data segment serving as an entry point from among the set of data segments D stored in the work area 41 to set the data segment as a target (S210). The processor 2 acquires all the data segments D connected to the target data segment D via the edges from the work area 41 (S211). The processor 2 computes the distances to the query from the target data segment D and all the data segments D connected to the target data segment D via the edges (S212). The processor 2 sets a data segment D located in a closest distance to the query as a target (S213). Through the processing from S211 to S213, a single hop in the nearest neighbor search in the L0 layer completes.

Following S213, the processor 2 determines whether the current target data segment D is closest to the query among the set of data segments D stored in the work area 41, i.e., the set of data segments D constituting the cluster CL corresponding to the representative data segment RD closest to the query (S214). The determination method in S214 is not limited to a particular method. For example, without a change of the target data segment D in the previous processing from S211 to S213, it can be inferred that the current target data segment D be closest to the query among the set of data segments D stored in the work area 41. Thus, without a change of the target data segment D in the previous processing from S211 to S213, the processor 2 determines that the current target data segment D is closest to the query among the set of data segments D stored in the work area 41. With a change of the target data segment D in the previous processing from S211 to S213, the processor 2 determines that the current target data segment D is not closest to the query.

When determining that the current target data segment D is not closest to the query among the set of data segments D stored in the work area 41 (S214: No), the processor 2 re-executes the processing from S211 to S214.

When determining that the current target data segment D is closest to the query among the set of data segments D stored in the work area 41 (S214: Yes), the processor 2 outputs the current target data segment D as a query response (S215). This completes the series of nearest neighbor search operations.

Query responses may be output in any manner. The processor 2 may generate a data segment containing a query response and store the data segment into a given memory, e.g., SSD 3. In a case that the information processing device 1 is connected to a printer or a display device, the processor 2 may output query responses to the printer or the display device. In a case that the information processing device 1 is connected to a network, the processor 2 may output query responses to another computer via the network.

The above has described the example that the processor 2 performs nearest neighbor search according to the graph in both the L1 layer and the cluster CL corresponding to the representative data segment RD closest to the query. The processor 2 may perform nearest neighbor search in either or both of the L1 layer and the cluster CL corresponding to the representative data segment RD closest to the query, by any method without using the graph.

For example, the processor 2 may identify the representative data segment RD closest to the query from among all the representative data segments RD in the L1 layer by calculating the distances between all the representative data segments RD in the L1 layer and the query. Similarly, the processor 2 may identify the data segment D closest to the query by calculating the distances between the query and all the data segments D constituting the cluster CL corresponding to the representative data segment RD closest to the query.

As described above, according to the embodiment the SSD 3 stores a plurality of clusters CL including data segments D. The data segments D are grouped into clusters CL according to the distances among the data segments D. The DRAM 4 stores a plurality of representative data segments RD corresponding one-to-one to the clusters CL. Each representative data segment RD is representative of the set of data segments D constituting the corresponding cluster CL. Upon receiving an input query, the processor 2 identifies a representative data segment RD closest to the input query from among the representative data segments RD. The processor 2 collectively reads a set of data segments D constituting the cluster CL corresponding to the identified representative data segment RD from the SSD 3. The processor 2 identifies a data segment D closest to the query from among the read set of data segments D, and outputs the identified data segment D as a query response.

Collectively reading the data segments D to be used for a nearest neighbor search in the L0 layer from the SSD 3 can shorten the time required for the query response, as compared with the comparative example that data is read from the SSD upon each hop. According to the embodiments, the query response speed can be thus improved.

According to the embodiments, the clusters CL are each arranged in the continuous area of the address space in the SSD 3.

Thereby, the processor 2 can acquire a set of necessary data segments D by a single read command.

According to the embodiments, the individual representative data segments RD are stored in the DRAM 4 in association with the head addresses of the areas arranging the corresponding clusters CL. The processor 2 acquires an address associated with the representative data segment RD identified as closest to the query, and transmits a read command designating the address to the SSD 3.

In addition, each of the representative data segments RD is obtained by computation from the set of data segments D constituting the corresponding cluster CL.

Modification

The above embodiments have described the example that each data segment D is included in only one cluster CL. Each data segment D may be included in two or more clusters CL.

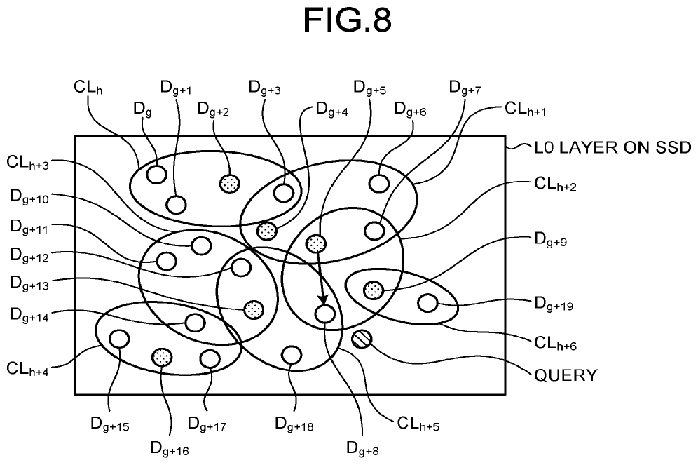

FIG. 8 is a schematic diagram for explaining a clustering method according to a modification of the embodiments.

FIG. 8 depicts part of the data segments D included in the L0 layer, i.e., a total of 20 data segments D_{g} to D_{g+19}. A set of data segments D_{g} to D_{g+3} constitutes a cluster CLₕ. A set of data segments D_{g+3} to D_{g+7} constitutes a cluster CLₕ₊₁. A set of data segments D_{g+5} and D_{g+7} to D_{g+9} constitutes a cluster CLₕ₊₂. A set of data segments D_{g+10} to D_{g+14} constitutes a cluster CLₕ₊₃. A set of data segments D_{g+14} to D_{g+17} constitutes a cluster CLₕ₊₄. A set of data segments D_{g+8}, D_{g+12}, D_{g+13}, and D_{g+18} constitutes a cluster CLₕ₊₅. A set of data segments D_{g+9} and D_{g+19} constitutes a cluster CLₕ₊₆.

Each of the data segments D_{g+3}, D_{g+5}, D_{g+7}, D_{g+8}, D_{g+9}, D_{g+12}, D_{g+13}, and D_{g+14} is included in two clusters CL. As such, one data segment D is allowed to be included in two clusters CL. This makes is possible to set a larger number of clusters CL by partially overlapping the distribution ranges of sets of data segments D between the adjacent clusters CL. Thus, a more accurate nearest neighbor search is feasible.

One data segment D may be allowed to be included in three or more clusters CL.

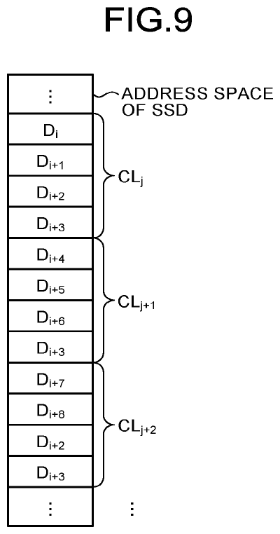

When a plurality of clusters CL is set such that one data segment D is included in two or more clusters CL, the data segments D are arranged in the address space of the SSD 3, for example, as illustrated in FIG. 9. FIG. 9 is a schematic diagram illustrating an arrangement method of the data segments D in a modification of the embodiments.

In the example illustrated in FIG. 9, a set of data segments Dᵢ to Dᵢ₊₃ constitutes a cluster CLⱼ and is arranged in a continuous area of the SSD 3. A set of data segments Dᵢ₊₃ to Dᵢ₊₆ constitutes a cluster CLⱼ₊₁ and is arranged in an area subsequent to the area arranging the set of data segments Dᵢ to Dᵢ₊₃ in the address space of the SSD 3. A set of data segments Dᵢ₊₂, Dᵢ₊₃, Dᵢ₊₇, and Dᵢ₊₈ constitutes a cluster CLⱼ₊₂ and is arranged in an area subsequent to the area arranging the set of data segments Dᵢ₊₃ to Dᵢ₊₆ in the address space of the SSD 3.

In the example illustrated in FIG. 9, the data segment Dⱼ₊₂ is included in the cluster CL; and the cluster CLⱼ₊₂. The data segment Dᵢ₊₃ is included in the cluster CLⱼ, the cluster CLⱼ₊₁, and the cluster CLⱼ₊₂. Thus, the data segment Dⱼ₊₂ is located in two areas, i.e., one arranging the set of data segments D constituting the cluster CLⱼ and the other arranging the set of data segments D constituting the cluster CLⱼ₊₂. The data segment Dᵢ₊₃ is located in three areas, i.e., one arranging the set of data segments D constituting the cluster CLⱼ, one arranging the set of data segments D constituting the cluster CLⱼ₊₁, and one arranging the set of data segments D constituting the cluster CLⱼ₊₂. As such, the data segments D included in two or more clusters CL are arranged in two or more locations in the address space of the SSD 3.

As described above, the data segments D stored in the SSD 3 may include a data segment or segments D included in two clusters CL.

As described in the embodiments and the modifications thereof, the nearest neighbor search space is hierarchized into two layers. One of the two layer is allocated to the SSD 3 serving as the first memory, and the other layer is allocated to the DRAM 4 serving as the second memory. Specifically, the SSD 3 serving as the first memory stores a plurality of clusters CL into which a plurality of data segments D is grouped according to the distances among the data segments D. The DRAM 4 serving as the second memory stores a plurality of representative data segments RD corresponding one-to-one to the clusters CL. Each representative data segment RD is representative of a set of data segments D constituting the corresponding cluster CL.

Thus, the processor 2 can collectively read a set of necessary data segments D from the layer allocated to the SSD 3. This can improve the query response speed in the embodiments and the modifications thereof, as compared with the comparative example. The SSD 3 serving as the first memory and the DRAM 4 serving as the second memory are connected to the bus 5. A device (first device) including at least the SSD 3, the DRAM 4, and the bus 5 may be provided separately from a device (second device) including at least the processor 2. The first device and the second device are connected via a given interface and circuitry.

Alternatively, the nearest neighbor search space may be hierarchized into three or more layers. For example, the uppermost layer among the three or more layers may be allocated to the DRAM 4 serving as the second memory, and the rest of the layers may be allocated to the SSD 3 serving as the first memory.

While certain embodiments have been described, these embodiments have been presented by way of example only, and are not intended to limit the scope of the inventions. Indeed, the novel methods and systems described herein may be embodied in different other forms; furthermore, various omissions, substitutions and varies in the form of the methods and systems described herein may be made without departing from the spirit of the inventions. The accompanying claims and their equivalents are intended to cover such forms or modifications as would fall within the scope and spirit of the inventions.

What is claimed is:

1. An information processing device comprising:
a first memory configured to store a plurality of clusters into which a plurality of first data segments is grouped according to a distance between the first data segments and each of which includes one or more first data segments;
a second memory being operable at a higher speed than the first memory, the second memory configured to store a plurality of second data segments corresponding one-to-one to the plurality of clusters, the plurality of second data segments being representative of the corresponding clusters; and
a processor configured to:
receive an input query,
identify a third data segment from among the plurality of second data segments, the third data segment being one of the second data segments closest to the query,
collectively read, from the first memory, one or more first data segments included in a cluster corresponding to the third data segment among the plurality of clusters,
identify a fourth data segment from among the one or more first data segments, the fourth data segment being one of the first data segments closest to the query, and
output the fourth data segment.

2. The information processing device according to claim 1, wherein
the plurality of clusters is individually arranged in a continuous area in an address space of the first memory to be used by the processor.

3. The information processing device according to claim 2, wherein
the plurality of second data segments is individually stored in the second memory in association with a head address of an area arranging a corresponding one of the clusters, and
the processor is further configured to acquire an address associated with the third data segment and transmit a read command designating the acquired address to the first memory.

4. The information processing device according to claim 1, wherein
the plurality of first data segments includes a fifth data segment that is included in both a first cluster and a second cluster among the plurality of clusters, the second cluster being different from the first cluster.

5. The information processing device according to claim 2, wherein
the plurality of first data segments includes a fifth data segment that is included in both a first cluster and a second cluster among the plurality of clusters, the second cluster being different from the first cluster.

6. The information processing device according to claim 3, wherein
the plurality of first data segments includes a fifth data segment that is included in both a first cluster and a second cluster among the plurality of clusters, the second cluster being different from the first cluster.

7. The information processing device according to claim 1, wherein
each of the plurality of second data segments is obtained by computation from one or more first data segments included in a corresponding one of the plurality of clusters.

8. The information processing device according to claim 2, wherein
each of the plurality of second data segments is obtained by computation from one or more first data segments included in a corresponding one of the plurality of clusters.

9. The information processing device according to claim 3, wherein
each of the plurality of second data segments is obtained by computation from one or more first data segments included in a corresponding one of the plurality of clusters.

10. The information processing device according to claim 4, wherein
each of the plurality of second data segments is obtained by computation from one or more first data segments included in a corresponding one of the plurality of clusters.

11. A method for controlling an information processing device comprising a first memory configured to store a plurality of clusters into which a plurality of first data segments is grouped according to a distance between the first data segments and each of which includes one or more first data segments; and a second memory being operable at a higher speed than the first memory and configured to store a plurality of second data segments corresponding one-to-one to the plurality of clusters, the plurality of second data segments being representative of the corresponding clusters, the method comprising:
receiving an input query;
identifying a third data segment from among the plurality of second data segments, the third data segment being one of the second data segments closest to the query;
collectively reading, from the first memory, one or more first data segments included in a cluster corresponding to the third data segment among the plurality of clusters;
identifying a fourth data segment from among the one or more first data segments, the fourth data segment being one of the first data segments closest to the query; and
outputting the fourth data segment.

12. The method according to claim 11, further comprising:
individually arranging the plurality of clusters in a continuous area in an address space of the first memory.

13. The method according to claim 12, further comprising:
individually storing the plurality of second data segments in the second memory in association with a head address of an area arranging a corresponding one of the clusters; and
acquiring an address associated with the third data segment and transmitting a read command designating the acquired address to the first memory.

14. The method according to claim 11, wherein
the plurality of first data segments includes a fifth data segment that is included in both a first cluster and a second cluster among the plurality of clusters, the second cluster being different from the first cluster.

15. The method according to claim 12, wherein
the plurality of first data segments includes a fifth data segment that is included in both a first cluster and a second cluster among the plurality of clusters, the second cluster being different from the first cluster.

16. The method according to claim 13, wherein
the plurality of first data segments includes a fifth data segment that is included in both a first cluster and a second cluster among the plurality of clusters, the second cluster being different from the first cluster.

17. The method according to claim 11, wherein
each of the plurality of second data segments is obtained by computation from one or more first data segments included in a corresponding one of the plurality of clusters.

18. The method according to claim 12, wherein
each of the plurality of second data segments is obtained by computation from one or more first data segments included in a corresponding one of the plurality of clusters.

19. The method according to claim 13, wherein
each of the plurality of second data segments is obtained by computation from one or more first data segments included in a corresponding one of the plurality of clusters.

20. An information processing device comprising:
a first memory configured to store a plurality of clusters into which a plurality of first data segments is grouped according to a distance between the first data segments and each of which includes one or more first data segments;
a second memory being operable at a higher speed than the first memory, the second memory configured to store a plurality of second data segments corresponding one-to-one to the plurality of clusters, the plurality of second data segments being representative of the corresponding clusters; and
a bus connected to the first memory and the second memory.
